(19) United States
(12) Patent Application Publication
(10) Pub. No.: US 2009/0318645 A1
(43) Pub. Date: Dec. 24, 2009

(54) METHOD FOR THE PRODUCTION OF OXETANE GROUP-CONTAINING (METH)ACRYLATES

(75) Inventors: Bardo Schmitt, Mainz (DE); Joachim Knebel, Alsbach-Haehnlein (DE); Silvia Beyer, Ober-Ramstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/375,418

(22) PCT Filed: Jun. 14, 2007
(86) PCT No.: PCT/EP07/55862

§ 371 Date: Jan. 28, 2009

(30) Foreign Application Priority Data
Aug. 22, 2006 (DE) 10 2006 039 245.0

(51) Int. Cl. C08F 4/72; C08F 120/18

(52) U.S. Cl. 526/170; 526/329.7

(57) ABSTRACT

The invention relates to a process for preparing oxetane-containing (meth)acrylates.

The invention relates to a process for preparing oxetane-containing methacrylates with high purity and minimal color increase during the preparation and their uses.

(Meth)acrylates have a wide variety of different fields of use. (Meth)acrylates are monomers which can be reacted in polymerization reactions, for example to give polymethacrylates. (Meth)acrylate polymers can also be used as binders or additives in paints, varnishes, coatings, etc.

JP 200063371 describes the synthesis of trimethylolpropaneoxetane methacrylate (3-methacryloyloxy-methyl-3-ethyloxetane), also including monomers which contain a spacer. This spacer is composed, for example, of alkoxylates including triethylene glycol. For this invention, though, higher degrees of ethoxylation of the trimethylolpropaneoxetane are of interest, since alcohols where n≧3 and with a distribution fall below polymer status and hence also the corresponding methacrylates. The preparation proceeds in the presence of basic catalysts, alkali metal alkoxides and tin compounds. In the case of these catalysts, a long reaction time is observed and, in the case of trimethylolpropaneoxetane methacrylate, a distillation is necessary to achieve a high purity.

J. Polymer Science: Part A: Polymer Chemistry, Vol. 41, p. 469-475 (2003) and EP 867443 describe the preparation of 3-(meth)acryloyloxymethyl-3-ethyloxetane via (meth)acryloyl chloride. However, the process is too expensive for industrial use, and the yield is additionally low.

JP 47025342 describes the synthesis of trimethylolpropaneoxetane methacrylate starting from sodium methacrylate and 3-ethyl-3-chloromethyloxetane in the presence of an amine catalyst. Here too, the yield is low.

Polymer Preprints 2004, 45(2), p. 24 describes the preparation of ethoxylated trimethylolpropaneoxetane acrylate by means of titanate catalysis. However, a color-causing stabilizer is used, and likewise an azeotroping agent. Moreover, the product is extracted with a water-ethanol mixture for purification in an additional working step. The comparative example addresses a modified process by means of titanate catalysis. Complicated workup steps have an adverse effect on the economic viability of the process.

It was an object of the invention to prepare oxetane-containing (meth)acrylates in high purity and with high yields.

The object was achieved by a process for preparing oxetane-containing methacrylates, characterized in that a zirconium catalyst is used and then residual monomers are removed from the mixture by distillation.

The notation “(meth)acrylate” here means both methacrylate, for example methyl methacrylate, ethyl methacrylate, etc., and acrylate, for example methyl acrylate, ethyl acrylate, etc., and mixtures of the two.

It has been found that, surprisingly, good yields can be achieved in the reaction of ethoxylated trimethylolpropaneoxetane with (meth)acrylates in the presence of zirconium catalysts. The products can also be prepared with high purity.

It has been found that, surprisingly, the use of zirconium catalysts does not influence the color number of the product. The color number of the product corresponds to that of the monomers.

It has also been found that, with uniform concentration of high boilers in the product, the concentration of the low boilers can be reduced considerably.

The catalysts used are zirconium compounds. Particular preference is given to zirconium(IV) acetylacetonate.

The amount of catalyst is 0.01 to 5% based on the amount of the alcohol.

Oxetane-containing alcohols may be monosubstituted or polysubstituted and have one or more alcoholic groups. Particular preference is given to using ethoxylated trimethylolpropaneoxetane.

The (meth)acrylates used may be all methacrylates, for example methyl methacrylate, ethyl methacrylate, etc. However, it is also possible to use acrylates, for example methyl acrylate, ethyl acrylate, etc., and also mixtures thereof. Particular preference is given to methyl methacylate.

The reaction is effected preferably in a column. The reactants are initially charged and the reaction mixture is dewatered by adjusting the top temperature of the column according to the monomer-water azeotrope used. For example, it is approx. 100° C. for methyl methacrylate.

After a short cooling phase, the catalyst and the amount of (meth)acrylate corresponding to the water-monomer azeotrope distilled off are added, and then the reaction mixture is reheated. The resulting azeotrope of (meth)acrylate and the parent alcohol is removed. The temperature is increased further and the reaction is conducted to completion with the top of the column closed.

For the workup of the reaction mixture, the catalyst is precipitated, the catalyst is removed by means of filtration and excess monomer is distilled off.

The particularly low color number enables many fields of use of the inventive oxetane-containing (meth)acrylates. They can preferably be used in dual-cure applications. The different reactive groups are suitable for the curing of formulations with different polymerization techniques, for example thermal and UV polymerization. The polymers find use in formulations, inter alia, as coatings, adhesives, polyelectrolytes, dental cement and inkjets.

The examples given below are given for better illustration of the present invention but are not capable of restricting the invention to the features disclosed herein.

### EXAMPLES

### Example 1

352.6 g (1.35 mol) of ethoxylated trimethylolpropane-oxetane (mean degree of ethoxylation=3.3)

770.0 g (7.7 mol) of methyl methacrylate

0.14 g (320 ppm based on product) of hydroquinone monomethyl ether (HQME)

0.006 g (15 ppm based on product) of phenothiazine

1.76 g (26 based on alcohol) of zirconium(IV) acetylacetonate

The mixture is dewatered and cooled briefly, and then catalyst and the amount of methyl methacrylate corresponding to the dewatering distillate distilled off is added and the mixture is heated again to boiling. The methyl methacrylate/methanol azeotrope is removed and then the top temperature is raised stepwise up to 100° C. After the reaction has ended, the mixture is cooled briefly, the catalyst is removed and the mixture is cooled to room temperature with stirring. After the filtration, the excess methyl methacrylate is distilled off on a rotary evaporator.

### Comparative Example 1

352.6 g (1.35 mol) of ethoxylated trimethylolpropane-oxetane (mean degree of ethoxylation=3.3)

770.0 g (7.7 mol) of methyl methacrylate

0.14 g (320 ppm based on product) of hydroquinone monomethyl ether (HQME)

0.006 g (15 ppm based on product) of phenothiazine

7.05 g (2% based on alcohol) of isopropyl titanate

The mixture is dewatered and cooled briefly, and then catalyst and the amount of methyl methacrylate corresponding to the dewatering distillate distilled off is added and the mixture is heated again to boiling. The methyl methacrylate/methanol azeotrope is removed and then the top temperature is raised stepwise up to 100° C. After the reaction has ended, the mixture is cooled briefly, the catalyst is removed and the mixture is cooled to room temperature with stirring. After the filtration, the excess methyl methacrylate is distilled off on a rotary evaporator.

| | | Comparative |
|---|---|---|
| Experiment | Example 1 | Example 1 |
| Catalyst/amount | Zirconium (IV) | Isopropyl |
| | acetylacetonate/0.5% | titanate/2% |
| Reaction time | 2.5 h | 2.5 h |
| Purity | 95.7 | 94.5 |
| Residual alcohol | 0.3 | 0.3 |
| Low boilers | 0.7 | 1.8 |
| High boilers | 2.0 | 1.8 |
| Colour number | 49 | 54 |

The color number of the raw material was 49.

Compared to the comparative example, Example 1 shows a higher purity and a lower proportion of the low boiler impurities which are attributable in the comparative example mainly to the isopropyl methacrylate formed in the reaction. The high boiler impurities and the residual alcohol content show comparable values in the two reactions.

In Example 1, no rise in the color number compared to the raw material is observed. In contrast, the reaction conditions under IPT catalysis contribute to a rise in the color number.

1. Process for preparing oxetane-containing (meth)acrylates, characterized in that a zirconium catalyst is added and then residual monomers are removed from the mixture by distillation.

2. Process according to claim 1, characterized in that zirconium catalysts are used.

3. Process according to claim 2, characterized in that zirconium (IV) acetylacetonate is used as the catalyst.

4. Use of oxetane-containing (meth)acrylates prepared according to claim 1 in dual-cure applications.

5. Use of oxetane-containing (meth)acrylates prepared according to claim 1 in adhesives, polyelectrolytes, dental cement, coatings and inkjets.
